(19) United States
(12) Patent Application Publication
(10) Pub. No.: US 2025/0296861 A1
(43) Pub. Date: Sep. 25, 2025

(54) A SYSTEM AND PROCESS FOR WASTEWATER TREATMENT

(71) Applicant: FLUENCE WATER PRODUCTS AND INNOVATION LTD., Caesarea (IL)

(72) Inventors: Neri NATHAN, Kibbutz Ein-Hahoresh (IL); Ronen SHECHTER, Tel Aviv (IL); Michael SHNITZER, Netanya (IL)

(73) Assignee: FLUENCE WATER PRODUCTS AND INNOVATION LTD., Caesarea (IL)

(21) Appl. No.: 18/861,687

(22) PCT Filed: May 18, 2023
(86) PCT No.: PCT/IL2023/050514

§ 371 Date: Oct. 30, 2024

Related U.S. Application Data
(60) Provisional application No. 63/344,058, filed on May 20, 2022.

(51) Int. Cl. C02F 3/20; C02F 3/00

(52) U.S. Cl. CPC C02F 3/208; C02F 3/006; C02F 2209/10; C02F 2209/22; C02F 2301/046

(57) ABSTRACT

The present disclosure provides a multi stage activated sludge system for biological wastewater treatment, having improved sludge settling properties, the multi stage activated sludge system comprising: an MABR tank comprising an MABR module, an MABR tank aeration unit configured for periodically aerating mixed liquor within the MABR tank, and an outlet from the MABR tank configured for selectively discharging partially settled sludge from the MABR tank, thus selecting for faster settling sludge.

### TECHNOLOGICAL FIELD

The present disclosure relates to wastewater treatment.

### BACKGROUND ART

References considered to be relevant as background to the presently disclosed subject matter are listed below:

International Patent Application Publication No. WO2022/069707

International Patent Application Publication No. WO2016/038606

Adav, S. S., Lee, D. J., Show, K. Y., & Tay, J. H. (2008). Aerobic granular sludge: Recent advances. Biotechnology Advances, 26 (5), 411-423.

Kreuk, M. d., Kishida, N., & Loosdrecht, M. v. (2007). Aerobic granular sludge-state of the art. Water Science and Technology, 55, 75-81.

Sepúlveda-Mardones, M., Campos, J. L., Magrí, A. Moving forward in the use of aerobic granular sludge for municipal wastewater treatment: an overview. Rev Environ Sci Biotechnol 18, 741-769 (2019).

Shechter, R. & Dagai, L. (2018) Simultaneous Nitrification, Denitrification and Bio-P Removal in Staged Membrane Aerated Biofilm Reactors, Proceedings of the Water Environment Federation 2018 (16): 1321-1327, DOI: 10.2175/19386471882513775

Acknowledgement of the above references herein is not to be inferred as meaning that these are in any way relevant to the patentability of the presently disclosed subject matter.

### BACKGROUND

WO2022/069707 describes a method for biomass densification in a biological treatment of a raw influent. The method comprises a step of subjecting the raw influent to a biological treatment of free suspended biomass, thereby producing a biomass comprising activated sludge; a step of separation and/or clarification of the activated sludge, thereby producing an effluent and a RAS; a step of extracting at least part of the RAS and/or part of the activated sludge as a first source of a WAS; a step of external density-based selection of at least part of the RAS and/or part of the activated sludge, thereby generating an overflow intended to be extracted as a second source of WAS, and an underflow comprising dense biomass aggregates; a step of producing and/or sustaining dense biomass aggregates, such as aerobic granular sludge or biofilm, by a dense biomass aggregates generating process, with at least part of the raw influent; a step of subjecting the dense biomass aggregates to the biological treatment; a step of subjecting the dense biomass aggregates of the underflow to the biological treatment and/or to the dense biomass aggregates generating process; thereby obtaining a densified biomass.

WO2016/038606 describes a water treatment module, a bioreactor comprising one or more of such modules and a receptive water treatment system and a method making use of the above module, bioreactor and system. The water treatment module comprises (i) at least one elongated gas enclosure comprising a gas inlet and two vertical walls, at least one vertical wall comprising a water-impermeable and gas-permeable membrane having a water-facing side and a gas-facing side, the two vertical walls separating between water external to said enclosure and gas within said enclosure, the gas enclosure being in a rolled or folded configuration to thereby define a convoluted horizontal path and one or more water-treatment spaces formed between opposite water facing sides of the enclosure; and (ii) a diffuser arrangement comprising gas diffusers configured for introducing a stream of gas into the one or more water treatment spaces.

Adav, S. S et al. reviews developments in aerobic biogranulation technology and applications in treating toxic industrial and municipal wastewaters. Factors affecting granulation, granule characterization, granulation hypotheses, effects of different operational parameters on aerobic granulation, response of aerobic granules to different environmental conditions, their applications in bioremediations, and possible future trends were delineated.

Kreuk, M. d., et al.. discusses the state of the art in using aerobic granular sludge in wastewater treatment, and later Sepúlveda-Mardones, M., et al. reviews the potential use of aerobic granular sludge (AGS) for simultaneous organic matter and nutrient removal using bioreactors and consuming less energy as an alternative to activated sludge technologies.

Shechter R and Dagai L describe the simultaneous nitrogen and phosphorus removal from different loads of wastewater in a staged membrane aerated biofilm reactor (MABR), on a side stream at a Water Resource Recovery Facility (WRRF). It was described that the simultaneous nitrification and denitrification (SND) was enabled by holding the aerobic MABR membranes in an anoxic environment in the presence of mixed liquor.

### GENERAL DESCRIPTION

The present invention relates to systems and methods for wastewater treatment, and more particularly to a multistage activated sludge systems, and corresponding methods, for biological wastewater treatment, having improved sludge settling properties.

The presently disclosed subject matter aims at implementing means for densification or granulation of sludge in order to improve performance of activated sludge systems. This is achieved, inter alia, through incorporating MABR modules with a configuration, as presently disclosed, that results in the densification or granulation and increase in settling velocity by a factor of more than 2 in some cases, allowing a higher hydraulic load rate on the secondary clarifiers of the activated sludge system.

The incorporation of an MABR within an activated sludge system, as disclosed herein, provides a complete hybrid solution for increasing treatment capacity. The granules or densified sludge benefit from the retention time in non-aerated conditions, which are required to obtain large and stable granules with better settling properties, while the MABR continues to nitrify in the same non-aerated volume, which would not be possible otherwise.

There is thus provided, according to a first aspect of the presently disclosed subject matter, a multi stage activated sludge system for biological wastewater treatment, having improved sludge settling properties, the activated sludge system comprising: an MABR tank comprising an MABR module, an MABR tank aeration unit configured for periodically aerating mixed liquor within the MABR tank, and an outlet from the MABR tank configured for selectively discharging partially settled sludge from the MABR tank, thus selecting for faster settling sludge. As appreciated by those versed in the art, the MABR tank has an inlet for mixed liquor or for wastewater and return activated sludge, and an outlet of mixed liquor.

According to a second aspect of the presently disclosed subject matter, there is provided a method for biological wastewater treatment in an activated sludge system comprising: an MABR tank comprising at least one MABR module and an MABR tank aeration unit, the method comprising: introducing a mixed liquor into the MABR tank; periodically aerating the mixed liquor within the MABR tank via the MABR tank aeration unit; periodically discharging partially settled sludge from the MABR tank as waste activated sludge (WAS), thus gradually selecting for a faster settling sludge over time.

According to a third aspect of the presently disclosed subject matter, there is provided a system for biological wastewater treatment with improved sludge settling properties, the system comprising: an MABR tank comprising at least one MABR module and a first aeration system; a mixing tank upstream of said MABR tank; an aerated tank downstream of said MABR tank, with a second aeration system; and a secondary clarifier downstream of the aerated tank; wherein a waste activated sludge stream from the secondary clarifier is discharged through a solids classifier, returning a stream with faster-settling solids to the mixing tank and discharging a stream with slower-settling solids from the system; and wherein wastewater is fed to the mixing tank and return activated sludge from the secondary clarifier is returned to the mixing tank.

According to a fourth aspect of the presently disclosed subject matter, there is provided a method for improving the sludge settling properties in an activated sludge system comprising an MABR tank including at least one MABR module, a mixing tank upstream of the MABR tank, an aerated tank downstream of the MABR tank and a secondary clarifier downstream of the aerated tank, wherein the MABR tank comprises a first aeration system and the aerated tank comprises a second aeration system, the method comprising: discharging waste activated sludge from the secondary clarifier through a solids classifier; returning a stream with faster-settling solids from the bottom of the solids classifier to the mixing tank; and discharging a stream with slower settling solids from the top of the solids classifier as waste activated sludge (WAS).

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A provides a schematic illustration of a MABR tank suitable for being included in an activated sludge system for biological wastewater treatment according to an example of the presently disclosed subject matter.

FIG. 1B provide a schematic illustration of an activated sludge system for biological wastewater treatment including the MABR tank of FIG. 1A, according to an example of the presently disclosed subject matter.

FIG. 2 provides a schematic illustration of an activated sludge system for biological wastewater treatment according to yet another example of the presently disclosed subject matter.

### DETAILED DESCRIPTION

The presently disclosed subject matter relates to systems and methods for biological wastewater treatment with improved sludge settling properties. For instance, according to some examples of the presently disclosed subject matter, the system can include an activated sludge system having a Membrane Aerated Biological Reactor (MABR) tank including at least one MABR module and an aeration unit for periodically aerating a liquid (for example, a liquid being treated) within the MABR tank, and partially settled sludge can be removed selectively from the MABR tank thereby improving the sludge settling properties.

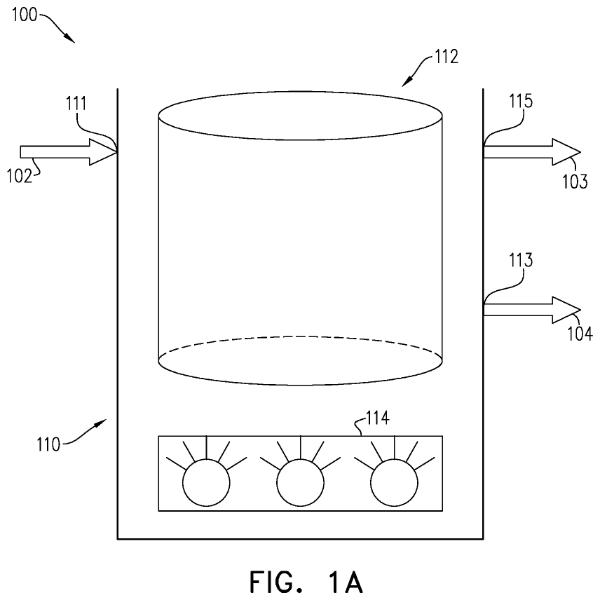

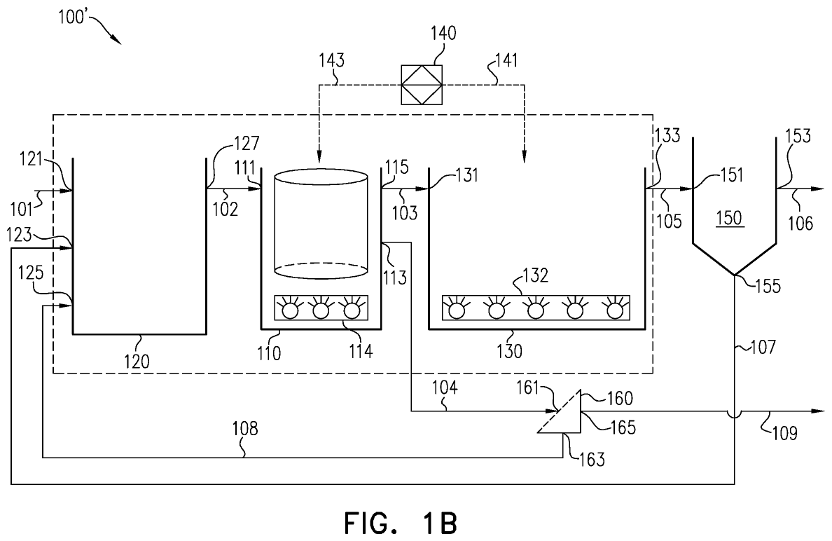

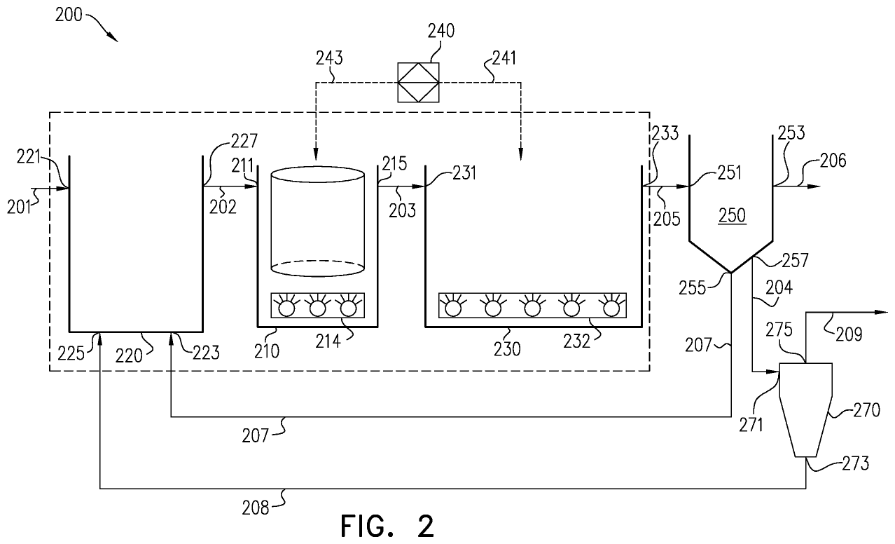

Reference is now made to FIG. 1A schematically illustrating an example for a MABR system 100 within an activated sludge system such as the one shown in FIG. 1B or FIG. 2 and a corresponding method for biological wastewater treatment with improved sludge settling properties, according to an example of the presently disclosed subject matter.

System 100 includes an MABR tank 110 having an MABR module 112 and an MABR tank aeration unit 114.

In some examples, MABR tank 110 can include more than one MABR modules. MABR tank 110 has an MABR tank inlet 111, an MABR tank first outlet 113, and an MABR tank second outlet 115. A mixed liquor stream 102 is fed to MABR tank 110 via MABR tank inlet 111.

Mixed liquor stream 102 is the stream of liquid that is to be treated within the MABR tank 110. MABR tank aeration unit 114 is configured to be controlled, for example by a controller (not shown), for periodically aerating the mixed liquor within MABR tank 110.

Mixed liquor includes sludge, some portion of which settles at the bottom of MABR tank 110 faster than a remaining portion of the sludge. The portion of the sludge that settles slower has been, herein for the purposes of the present description, referred to as partially settled sludge.

The partially settled sludge constitutes that portion of the sludge that at a given time from turning the mixing off does not settle at the bottom of the MABR tank 110 and remains partially suspended (or in other words, settles partially) at a certain height above the bottom of MABR tank 110.

MABR tank first outlet 113 is positioned at a location corresponding to that certain height above the bottom of the MABR tank 110 for selectively discharging the partially settled sludge stream 104 from MABR tank 110, thereby selecting for the faster settling sludge at the bottom of the MABR tank 110. The partially settled sludge is discharged from system 100 as waste activated sludge (WAS).

Accordingly, in some examples, MABR tank first outlet 113 can be positioned at a location above 20% of the total height of MABR tank 110 from the bottom of the MABR tank 110 and below 50% of the total height of MABR tank 110 from the bottom of the MABR tank 110.

In some examples, MABR tank first outlet 113 can be positioned at a location above 40 cm from the bottom of MABR tank 110 and below 50% of the total height of MABR tank 110 from the bottom of MABR tank 110.

In some examples, MABR tank first outlet 113 can include a plurality of outlets, each positioned according to any one of the above-mentioned criteria for positioning the MABR tank first outlet 113.

In some examples, the outlets of the plurality of outlets can be located at different heights along MABR tank 110 while meeting the above-mentioned criterion for positioning MABR tank first outlet 113. Each of the plurality of outlets can be configured for selectively discharging the partially settled sludge from MABR tank 110. The plurality of outlets 113 enable plant operators to optimize the discharge depth, which might change with time, as sludge settling properties gradually improve.

MABR tank second outlet 115 is located more closer to the top of MABR tank 110 than MABR tank first outlet 113 and discharges the mixed liquor stream 103 from MABR tank 110 as the treated mixed liquor, for example, to downstream stages of the activated sludge system.

MABR tank aeration unit 114 is periodically switched between one or more ON periods, during which air is introduced into the mixed liquor, and one or more OFF periods during operation of system 100, and the partially settled sludge is discharged from MABR tank 110 during at least one of the one or more OFF periods.

In other words, the partially settled sludge is discharged from MABR tank 110 when the MABR tank aeration unit is OFF, i.e., the mixed liquor within MABR tank 110 is not being aerated.

Reference is now made to FIG. 1B illustrating a schematic block diagram of an activated sludge system 100′ and a corresponding method for biological wastewater treatment with improved sludge settling properties, according to an example of the presently disclosed subject matter.

System 100′ includes all components of system 100 described above with respect to FIG. 1A, which are configured to operate in the same manner as described above, and therefore have been designated by the same reference numerals.

For instance, system 100′ includes an MABR tank 110 having an MABR module 112 and an MABR tank aeration unit 114. MABR tank 110 has an MABR tank inlet 111, an MABR tank first outlet 113, and an MABR tank second outlet 115. A mixed liquor stream 102 is fed to the MABR tank 110 via the MABR tank inlet 111. The mixed liquor stream 102 is the stream of liquid that is to be treated within MABR tank 110. A partially settled sludge stream 104 is discharged from the MABR tank 110 via the MABR tank first outlet 113 and a mixed liquor stream 103 is discharged from the MABR tank 110 via MABR tank second outlet 115.

It is to be understood herein that the description of the components of the system 100 and operations thereof described above with respect to FIG. 1A applies mutatis mutandis to the corresponding components of system 100′.

As shown in FIG. 1B, a stream 101 of the wastewater to be treated is fed to (or introduced into) MABR tank 110 via a mixing tank 120 upstream of MABR tank 110. Mixing tank 120 has a mixing tank first inlet 121 to receive stream 101 of the wastewater to be treated, into mixing tank 120, a mixing tank second inlet 123 for receiving return activated sludge (RAS) (described in detail later herein below) into mixing tank 120, and a mixing tank third inlet 125 for receiving partially clarified water (described in detail later herein below) into mixing tank 120. The wastewater to be treated, the return activated sludge (RAS), and the partially clarified water are mixed within mixing tank 120 to obtain a stream of mixed liquor 102, which is discharged from a mixing tank outlet 127 and is fed (or allowed to flow) into MABR tank 110 via the MABR tank inlet 111. Additional streams arising from routine operation of a wastewater treatment facility may also be introduced into mixing tank 120, or that such additional streams may be part of the wastewater stream 101 fed to mixing tank 120 through first inlet 121.

System 100′ further includes an activated sludge aeration tank 130 including an activated sludge aeration unit 132, for example a diffuser arrangement located on the bottom of the activated sludge aeration tank 130. The mixed liquor stream 103 is fed to (or allowed to flow into) the activated sludge aeration tank 130 via an activated sludge aeration tank inlet 131 from MABR tank second outlet 115. The mixed liquor is subjected to aeration in activated sludge aeration tank 130 and a treated stream of mixed liquor 105 is discharged from the activated sludge aeration tank 130 via an activated sludge aeration tank outlet 133.

In some preferred examples of the presently disclosed activated sludge aeration unit 132 is controlled by a controller 140 to regulate the aeration duration and/or intensity of the mixed liquor within activated sludge aeration tank 130. In some preferred examples, controller 140 is configured to control activated sludge aeration unit 132 to maintain a dissolved oxygen (DO) concentration of less than 1 mg/l in activated sludge aeration tank 130. Regulation of aeration intensity may be obtained by variation of the operation of at least one of the blowers providing the air to the unit, such as through a variable speed drive or by turning said at least one of the blowers on and off.

In some examples, controller 140 is configured to receive process parameters and control second aeration system 132 based on said process parameters. In some examples, the process parameters may be selected from the group consisting of dissolved oxygen (DO) concentration, oxidation reduction potential (ORP), ammonia concentration and nitrate concentration. For example, air supply provided by second aeration system 132 can be controlled by a setpoint for DO and the set point may be increased or decreased in aerated tank 130 according to ammonia and nitrate concentrations. Further for example, the setpoint may be increased if the ammonia concentration is high or decreased if the nitrate concentration is high.

In some examples, process parameters are retrieved from dedicated sensors (not illustrated).

Activated sludge aeration tank outlet 133 discharges the stream 105 of the mixed liquor which is fed to (or allowed to flow into) a secondary clarifier 150 via a secondary clarifier inlet 151. Secondary clarifier 150 separates the mixed liquor into a clarified effluent, which is discharged from a secondary clarifier first outlet 153 as a clarified effluent stream 106, and the return activated sludge (RAS), which is discharged from a secondary clarifier second outlet 155 as RAS stream 107. RAS stream 107 is fed into (e.g.

pumped into) the mixing tank 120 via mixing tank second inlet 123.

System 100′ further comprises a solid-liquid separator 160, which in some examples can include a screen based or gravity-based or centrifugal separator.

The partially settled sludge stream 104 is discharged as waste activated sludge (WAS) from the system 100′ via solid-liquid separator 160. A solids concentration is increased in the WAS within the solid-liquid separator 160 prior to being discharged from the system 100′. For instance, the partially settled sludge is separated into a partially clarified water and a WAS with increased solids-concentration. The partially settled sludge stream 104 is fed into (pumped to or allowed to flow into) the solid-liquid separator 160 from the MABR tank first outlet 113 via a solid-liquid separator inlet 161. The partially clarified water is discharged from the solid-liquid separator 160 via a solid-liquid separator first outlet 163 as the partially clarified water stream 108 and is fed into (pumped to or allowed to flow into) the mixing tank 120 via the mixing tank third inlet 125. The WAS with increased solids-concentration is discharged from the solid-liquid separator 160 as the WAS stream 109 via a solid-liquid separator second outlet 165.

In some examples, a suitable flocculating agent and/or a coagulant as known in the art is added to the partially settled sludge within or prior to feeding into the solid-liquid separator 160 to improve the settling properties or filterability of the sludge.

The partially settled sludge is discharged from MABR tank 110 while MABR tank aeration unit 114 is not aerating the mixed liquor within MABR tank 110. For instance, MABR tank aeration unit 114 is controlled by controller 140, to be periodically switched between one or more ON periods, during which air is introduced into the mixed liquor, and one or more OFF periods during operation of system 100′, and the partially settled sludge is discharged from MABR tank 110 during at least one of the one or more OFF periods. Preferably there is a time period between turning off the mixing aeration and discharging partially settled sludge from MABR tank 110 through outlet 113, in order to allow the fast-settling sludge to settle below the depth of outlet 113. The set point for this time period between turning off the mixing aeration and opening the discharge through outlet 113 is changeable in controller 140 by the plant operator, in order to enable performance optimization.

In some examples, system 100′ can include separate controllers for aeration unit 114 and aeration unit 132 but the discharge of partially settled sludge stream 104 through outlet 113 is always controlled by the same controller as aeration unit 114 of MABR tank 110.

It is to be understood herein that all of the description of MABR tank first outlet 113 of system 100 provided above with respect to FIG. 1A applies equally to MABR tank first outlet 113 of the system 100′. Furthermore, all of the description of the partially settled sludge of system 100 provided above with respect to FIG. 1A applies equally to the partially settled sludge of the system 100′.

Further, MABR tank aeration unit 114, of any or both the systems 100 and 100′, can include a diffuser arrangement located at a bottom portion of MABR tank 110.

Further, MABR module 112, of any or both the systems 100 and 100′, can include a membrane configuration selected from the group consisting of flat sheet membrane, hollow fibers membranes, and spirally wound membrane.

Reference is now made to FIG. 2 illustrating a schematic block diagram of an activated sludge system 200 and a corresponding method for biological wastewater treatment with improved sludge settling properties, according to an example of the presently disclosed subject matter.

System 200 includes an MABR tank 210 having an MABR module 212 and a first aeration system 214. In some examples, MABR tank 210 can include more than one

MABR modules. MABR tank 210 has an MABR tank inlet 211 and an MABR tank outlet 215.

System 200 includes a mixing tank 220 upstream of MABR tank 210. A stream 201 of the wastewater to be treated is fed to (or introduced into) MABR tank 210 via the mixing tank 220. Mixing tank 220 has a mixing tank first inlet 221 to receive the stream 201 of the wastewater to be treated into mixing tank 220, a mixing tank second inlet 223 for receiving return activated sludge (RAS) (described in detail later herein below) into mixing tank 220, and a mixing tank third inlet 225 for receiving a stream of faster-settling solids (described in detail later herein below) into mixing tank 220. The wastewater to be treated, the return activated sludge (RAS), and the stream of faster-settling solids are mixed within mixing tank 220 to obtain a stream of mixed liquor 202, which is discharged from a mixing tank outlet 227 and is fed (or allowed to flow) into MABR tank 210 via MABR tank inlet 211. Mixing tank 220 may also serve as a selector or as an anaerobic tank for enhance biological phosphorous removal, depending on the hydraulic residence time of the wastewater, as known in the art. The mixing in tank 220 may be provided by mechanical agitation or pumping or even intermittent short bursts of air through coarse bubbles diffusers, or other means as suitable.

The mixed liquor is treated within MABR tank 210, while the wastewater is treated by MABR module 212 and the mixed liquor is periodically subjected to aeration by first aeration system 214.

In some examples, MABR module 212 can include a membrane configuration selected from the group consisting of flat sheet membranes, hollow fiber membranes, and spirally wound membranes.

In some examples, first aeration system 214 can include a diffuser arrangement located at a bottom portion of MABR tank 210.

System 200 further includes an aerated tank 230 downstream of MABR tank 210 and including a second aeration system 232, for example a diffuser arrangement located on the bottom of aerated tank 230. The mixed liquor stream 203 (after treatment within MABR tank 210) is fed into (allowed to flow into) aerated tank 230 from MABR tank outlet 215 via an aerated tank inlet 231. The mixed liquor is subjected to aeration in aerated tank 230 by second aeration system 232, and a treated stream of mixed liquor 205 is discharged from aerated tank 230 via an aerated tank outlet 233.

Second aeration system 232 is controlled by a controller 240 (interchangeably used herein with control unit) to regulate the aeration duration and/or intensity of the mixed liquor within aerated tank 230. Preferably, controller 240 is configured to control second aeration system 232 to maintain a DO concentration in a range of about 0.1 mg/l and about 1.0 mg/l in aerated tank 230. The regulation of aeration intensity may be obtained by variation of the operation of at least one of the blowers providing the air to the unit, such as through a variable speed drive or by turning said at least one of the blowers on and off.

In some examples, controller 240 is configured to receive process parameters and control second aeration system 232 based on said process parameters. In some examples, the process parameters may be selected from the group consisting of dissolved oxygen (DO) concentration, oxidation reduction potential (ORP), ammonia concentration and nitrate concentration. For example, air supply provided by second aeration system 232 can be controlled by a setpoint for DO and the set point may be increased or decreased in the range of about 0.1 mg/l and about 1.0 mg/l in aerated tank 230 according to ammonia and nitrate concentrations. Further for example, the setpoint may be increased if the ammonia concentration is high or decreased if the nitrate concentration is high.

In some examples, process parameters are retrieved from dedicated sensors (not illustrated).

Controller 240 is further configured to control, via a control line 243, first aeration system 214 to periodically switch between one or more ON periods, during which air is introduced into the mixed liquor, and one or more OFF periods.

In some examples, system 200 can include a separate controller (from controller 240) for controlling first aeration system 214.

Aerated tank outlet 233 discharges stream 205 of the mixed liquor which is fed to (allowed to flow into) a secondary clarifier 250 via a secondary clarifier inlet 251. In some examples, secondary clarifier 250 is a gravity based separator. Secondary clarifier 250 separates the mixed liquor into a clarified effluent, which is discharged from a secondary clarifier first outlet 253 as a clarified effluent stream 206, return activated sludge (RAS), which is discharged from a secondary clarifier second outlet 255 as RAS stream 207, and a waste activated sludge (WAS), which is discharged from a secondary clarifier third outlet 257 as a WAS stream 204. The RAS stream 207 is fed into (pumped to or allowed to flow into) mixing tank 220 via mixing tank second inlet 223.

System 200 further comprises a solids classifier 270, which in some examples can include a screen based or gravity-based separator. In some examples, the solids classifier 270 can include a gravity-based separator selected from the group consisting of a hydro cyclone and an elutriator.

WAS stream 204 is discharged from system 200 via solids classifier 270. The solids classifier 270 operates on WAS stream 204 to separate WAS stream 204 into a stream 208 with faster-settling solids, which is discharged from a solids classifier first outlet 273 located at bottom of solids classifier 270, and a stream 209 with slower settling solids, which is discharged as WAS from a solids classifier second outlet 275 located at the top side of solids classifier 270.

Stream 208 with faster-settling solids is returned to (pumped to or allowed to flow into) mixing tank 220 via mixing tank third inlet 225 and stream 209 with slower settling solids is discharged from system 200 as WAS.

In some examples, controller 240 (or a different controller) can be configured for controlling operation of solids classifier 270 to thereby maintain a desired value of suspended solids concentration in the mixed liquor, as measured, for example, in mixing tank 220.

1. A multi-stage activated sludge system for biological wastewater treatment, having improved sludge settling properties, the activated sludge system comprising:
an MABR tank comprising an MABR module, an MABR tank aeration unit configured for periodically aerating mixed liquor within the MABR tank, and an outlet from the MABR tank configured for selectively discharging partially settled sludge from the MABR tank, thus selecting for faster settling sludge.

2. The system of claim 1, wherein the MABR tank aeration unit is configured to be periodically switched between one or more ON periods and one or more OFF periods, and wherein the system is configured to discharge the partially settled sludge from the MABR tank during at least one of the one or more OFF periods.

3-5. (canceled)

6. The system of claim 1, comprising a solid-liquid separator for discharging the partially settled sludge discharged from the MABR tank as waste activated sludge (WAS).

7. (canceled)

8. (canceled)

9. The system of claim 6, wherein the water from the solid-liquid separator is returned to a mixing tank upstream of the MABR tank, and wherein return activated sludge (RAS) and wastewater to be treated are also fed to said mixing tank upstream of the MABR tank.

10. (canceled)

11. The system of claim 1, wherein said MABR tank outlet for partially settled mixed liquor is positioned at a location above 20% of the height or 40 cm from the bottom of the MABR tank and below 50% of the height of the MABR tank measured from bottom of the MABR tank.

12. The system of claim 11, wherein said MABR tank outlet comprises two or more outlets located at different heights along the MABR tank, each of the two or more outlets being configured for selectively discharging the partially settled sludge.

13. (canceled)

14. The system of claim 1, wherein the activated sludge system further comprises an activated sludge aeration tank downstream to said MABR tank and comprising a diffuser arrangement located at a bottom portion of the activated sludge aeration tank and configured to maintain DO concentration in said activated sludge aeration tank below 1 mg/l.

15. A method for biological wastewater treatment comprising:
introducing a mixed liquor into a MABR tank;
periodically aerating the mixed liquor within said MABR tank via said MABR tank aeration unit;
periodically discharging partially settled sludge from said MABR tank as waste activated sludge (WAS), thus gradually selecting for a faster settling sludge over time.

16. The method of claim 15, wherein said periodically aerating the mixed liquor within the MABR tank via the MABR tank aeration unit comprises periodically switching the MABR aeration unit between one or more ON periods and one or more OFF periods and discharging the partially settled sludge from the MABR tank during at least one of the one or more OFF periods.

17. (canceled)

18. The method of claim 16, further comprising:
introducing air intermittently or periodically into the mixed liquor within said MABR tank through said MABR tank aeration unit during the one or more ON periods; and
periodically discharging the partially settled sludge from the MABR tank during at least one of the one or more OFF periods; and
maintaining a DO concentration of less than 1 mg/l in the-an activated sludge tank downstream of said MABR tank.

19. The method of claim 15, further comprising:
increasing the solids concentration of the partially settled mixed liquor discharged as WAS within a solid-liquid separator;
recirculating clarified water from the solid-liquid separator to the activated sludge system; and
discharging the WAS with increased solids concentration from the solid-liquid separator.

20. The method of claim 19, further comprising:
feeding a wastewater to be treated into a mixing tank upstream of the MABR tank;
feeding a return activated sludge (RAS) into the mixing tank; feeding the water from the solid-liquid separator into the mixing tank; and
allowing the mixed liquor to flow from the mixing tank into the MABR tank.

21. The method of claim 20, further comprising:
allowing the mixed liquor to flow from the MABR tank into an activated sludge aeration tank and then into a secondary clarifier;
separating within the secondary clarifier the mixed liquor into a clarified effluent and the RAS; and
discharging the clarified effluent from the secondary clarifier.

22. A system for biological wastewater treatment with improved sludge settling properties, the system comprising:
an MABR tank comprising at least one MABR module and a first aeration system;
a mixing tank upstream of said MABR tank;
an aerated tank downstream of said MABR tank, with a second aeration system; and
a secondary clarifier downstream of the aerated tank;
wherein a waste activated sludge stream from the secondary clarifier is discharged through a solids classifier, returning a stream with faster-settling solids to the mixing tank and discharging a stream with slower-settling solids from the system; and
wherein wastewater is fed to the mixing tank and return activated sludge from the secondary clarifier is returned to the mixing tank.

23-28. (canceled)

29. The system of claim 22, comprising a control unit is configured to perform any one or a combination of:
introducing air intermittently or periodically into mixed liquor within said MABR tank through said first aeration system; and
controlling operation of said second aeration system,
maintaining dissolved oxygen concentration of less than 1.0 mg/l in said aerated tank; and
controlling the operation of said solids classifier to thereby maintain a solids concentration suspended in said mixing tank.

30. (canceled)

31. (canceled)

32. A method for improving the sludge settling properties in an activated sludge system comprising an MABR tank including at least one MABR module, a mixing tank upstream of the MABR tank, an aerated tank downstream of the MABR tank and a secondary clarifier downstream of the aerated tank, wherein the MABR tank comprises a first aeration system and the aerated tank comprises a second aeration system, the method comprising:
discharging waste activated sludge from the secondary clarifier through a solids classifier;
returning a stream with faster-settling solids from the bottom of the solids classifier to the mixing tank; and
discharging a stream with slower settling solids from the top of the solids classifier as waste activated sludge (WAS).

33. (canceled)

34. (canceled)

35. The method of claim 32, comprising aerating said MABR tank intermittently or periodically through the first aeration system MABR tank aeration unit.

36. The method of claim 32, comprising maintaining a DO concentration of less than 1.0 mg/l in said aerated tank.
